(19) United States
(12) Patent Application Publication
(10) Pub. No.: US 2023/0086563 A1
(43) Pub. Date: Mar. 23, 2023

(54) REINFORCEMENT LEARNING APPARATUS AND REINFORCEMENT LEARNING METHOD FOR OPTIMIZING POSITION OF OBJECT BASED ON DESIGN DATA

(71) Applicant: AGILESODA INC., Seoul (KR)

(72) Inventors: Ye Rin MIN, Namyangju-si (KR); Yeon Sang YU, Gwangju (KR); Sung Min LEE, Seongnam-si (KR); Won Young CHO, Yeosu-si (KR); Ba Da KIM, Seoul (KR); Dong Hyun LEE, Seongnam-si (KR)

(73) Assignee: AGILESODA INC., Seoul (KR)

(21) Appl. No.: 17/878,451

(22) Filed: Aug. 1, 2022

(30) Foreign Application Priority Data
Sep. 17, 2021 (KR) 10-2021-0124864

(51) Int. Cl. G06F 30/3308; G06F 30/27; G06F 30/347

(52) U.S. Cl. CPC G06F 30/3308; G06F 30/27; G06F 30/347; G06F 2119/18

(57) ABSTRACT

Disclosed are a reinforcement learning apparatus and a reinforcement learning method for optimizing the position of an object based on design data. The present disclosure may configure a learning environment based on design data of a user and generate the optimal position of a target object, installed around a specific object during a design or manufacturing process, through reinforcement learning using simulation.

### CROSS-REFERENCE TO RELATED APPLICATION(S)

This application is based on and claims priority under 35 U.S.C. 119 to Korean Patent Application No. 10-2021-0124864, filed on Sep. 17, 2021, in the Korean Intellectual Property Office, the disclosure of which is herein incorporated by reference in its entirety.

### BACKGROUND

### 1. Field

The present disclosure relates to a reinforcement learning apparatus and a reinforcement learning method for optimizing the position of an object based on design data and, more specifically, to a reinforcement learning apparatus and a reinforcement learning method for optimizing the position of an object based on design data, wherein a learning environment is configured based on design data of a user, and the optimal position of a target object installed around a specific object during a design or manufacturing process is generated through reinforcement learning using simulation.

### 2. Description of Prior Art

In order to mass-produce a product, a design process for a product to be manufactured is required. In the design process, workers perform designing by hand. During the design process, it is sometimes necessary to place, under various conditions, a target object around a predetermined object. Workers have to find an optimal position and perform designing by hand, and thus work time and manpower may be increased, and work efficiency may be significantly decreased.

Furthermore, there is a problem in that the results of mass-produced products are inconsistent because workers have different types of know-how.

Reinforcement learning is a learning method for dealing with agents which achieve goals while interacting with the environment and, and is widely used in the field of artificial intelligence.

The purpose of the reinforcement learning is to find out what actions the reinforcement learning agent, which is a subject of the learning, ought to take in order to receive more rewards.

That is, the reinforcement learning is learning what to do in order to maximize reward even when there is no fixed answer, and includes the process of learning to maximize reward through trial and error, rather than listening what action to take in advance in a situation wherein an input and an output have a clear relationship.

Furthermore, an agent may sequentially select an action as a time step passes, and may receive a reward based on the effect of the action on an environment.

FIG. 1 is a block diagram showing the configuration of a reinforcement learning apparatus according to the prior art. As shown in FIG. 1, an agent 10 may learn how to determine an action (or behavior) A through learning of a reinforcement learning model, each action A may affect a next state S, and the degree of success may be measured as a reward R.

That is, the reward is a reward score for an action (behavior) which the agent 10 determines based on any state when learning is performed through the reinforcement model, and may be a type of feedback on decision-making of the agent 10 according to the learning.

An environment 20 may be all rules such as actions capable of being taken by the agent 10 and rewards according thereto, a state, an action, a reward, etc. may all be elements of the environment, and all predetermined things other than the agent 10 may be the environment.

Through reinforcement learning, the agent 10 may take an action such that a future reward is maximized, and thus how to set a reward may greatly affect a learning result.

In the actual work environment, workers perform designing by hand. This may require considerable work time and manpower, and may remarkably reduce work efficiency.

Furthermore, each work has different know-how, and thus results of mass-produced products may not be consistent.

### SUMMARY

The present disclosure has been made in order to solve the above-mentioned problems, and it is an aspect of the present disclosure to provide a reinforcement learning apparatus and a reinforcement learning method for optimizing the position of an object based on design data, wherein a learning environment is configured based on design data of a user, and the optimal position of a target object installed around a specific object during a design or manufacturing process is generated through reinforcement learning using simulation.

In accordance with an aspect of the present disclosure, a reinforcement learning apparatus for optimizing the position of an object based on design data, according to an embodiment, may include: a simulation engine configured to analyze, based on design data including information about all objects, an individual object and position information of the object, generate simulation data constituting a reinforcement environment in which a predetermined constraint is configured for the analyzed individual object, request optimization information for placing a target object around at least one individual object, perform simulation for the placement of the target object, based on state information including target object placement information used for reinforcement learning and an action provided from a reinforcement learning agent, and provide reward information according to the simulation result as feedback on decision-making of the reinforcement learning agent; a reinforcement learning agent configured to perform reinforcement learning based on the state information and the reward information provided from the simulation engine to determine an action such that the placement of the target object around the object is optimized; and a design data unit configured to provide, to the simulation engine, the design data including the information about the all objects.

Furthermore, the design data according to the embodiment may be semiconductor design data including CAD data or netlist data.

Furthermore, an application program visualized through a web may be additionally installed in the simulation engine according to the embodiment.

Furthermore, the simulation engine according to the embodiment may include: a reinforcement learning environment configuration unit configured to analyze, based on design data including information about all objects, an individual object and position information of the object, generate a predetermined constraint and simulation data constituting a reinforcement environment for each object, and make, based on the simulation data, a request to the reinforcement learning agent for optimization information for placing a target object around at least one individual object; and a simulation unit configured to perform, based on an action received from the reinforcement learning agent, simulation for configuring a reinforcement learning environment for the placement of the target object, and provide, to the reinforcement learning agent, reward information and state information including target object placement information used for reinforcement learning.

Furthermore, the reward information according to the embodiment may be calculated based on the distance between an object and a target object or the position of the target object.

Further, according to an embodiment of the present disclosure, a reinforcement learning method for optimizing the position of an object based on design data may include: a) analyzing, by a simulation engine, an individual object and position information of the object when design data including information about all objects is uploaded, and generating simulation data constituting a reinforcement environment in which a predetermined constraint is configured for the individual object; b) when a reinforcement learning agent receives an optimization request for the placement of a target object around an individual object based on the simulation data from the simulation engine, performing reinforcement learning based on reward information and state information including target object placement information, which is collected from the simulation engine and used for the reinforcement learning, to determine an action such that the placement of the target object is optimized; and c) performing, by the simulation engine, simulation for configuring a reinforcement environment for the placement of the target object, based on an action provided from the reinforcement learning agent, and providing, to the reinforcement learning agent, reward information according to the result of performing the simulation as feedback on decision-making of the reinforcement learning agent, and the state information including the target object placement information used for reinforcement learning.

Furthermore, the reward information according to the embodiment may be calculated based on the distance between an object and a target object or the position of the target object.

Furthermore, the design data according to the embodiment may be semiconductor design data including CAD data or netlist data.

Furthermore, the method may further include converting the simulation data according to the embodiment into an extensible markup language (XML) file such that the simulation data is used through a web.

The present disclosure is advantageous in that a learning environment may be configured based on design data of a user, and the optimal position of a target object installed around a specific object during a design or manufacturing process may be generated and provided through reinforcement learning using simulation.

Furthermore, the present disclosure is advantageous in that design accuracy may be improved by providing a learning environment similar to a real environment, based on data designed by the user while the user performs 3D designing.

Furthermore, the present disclosure is advantageous in that the work efficiency may be improved by automatically generating the optimized position of a target object through reinforcement learning, based on data designed by the user.

Furthermore, the present disclosure is advantageous in that different types know-how of workers may be unified, thereby minimizing deviations in results and mass-producing products having an identical quality.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram showing the configuration of a normal reinforcement learning apparatus;

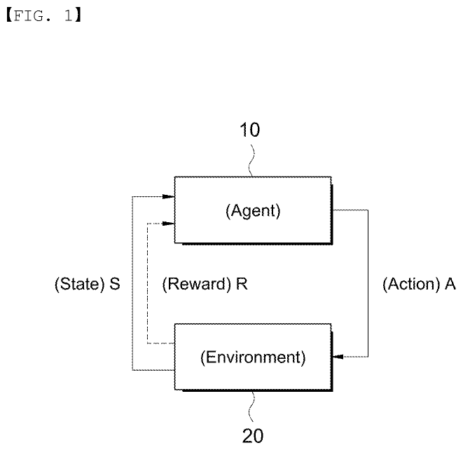

FIG. 2 is a block diagram showing the configuration of a reinforcement learning apparatus for optimizing the position of an object based on design data according to an embodiment of the present disclosure;

FIG. 3 is a block diagram showing the configuration of a simulation engine of the reinforcement learning apparatus for optimizing the position of an object based on design data according to the embodiment in FIG. 2;

FIG. 4 is a flowchart showing a reinforcement learning method for optimizing the position of an object based on design data according to an embodiment of the present disclosure;

FIG. 5 is an illustration of design data shown for describing a reinforcement learning method for optimizing the position of an object based on design data according to an embodiment of the present disclosure.

FIG. 6 is an illustration of object information data shown for describing a reinforcement learning method for optimizing the position of an object based on design data according to an embodiment of the present disclosure;

FIG. 7 is an illustration of simulation data shown for describing a reinforcement learning method for optimizing the position of an object based on design data according to an embodiment of the present disclosure;

FIG. 8 is an illustration shown for describing a simulation process of a reinforcement learning method for optimizing the position of an object based on design data according to an embodiment of the present disclosure;

FIG. 9 is another illustration shown for describing the simulation process according to the embodiment in FIG. 8; and

FIG. 10 is an illustration shown for describing a rewarding process of a reinforcement learning method for optimizing the position of an object based on design data according to an embodiment of the present disclosure.

### DETAILED DESCRIPTION

Hereinafter, the present disclosure will be described in detail with reference to preferred embodiments of the present disclosure and the accompanying drawings, but will be described on the assumption that the same reference numerals in the drawings denote the same elements.

Prior to describing the specific content for implementation of the present disclosure, it should be note that a configuration which is not directly related to the technical gist of the present disclosure has been omitted within a range in which the technical of the present disclosure is not disturbed.

Furthermore, terms or words used in the present specification and claims should be interpreted as meanings and concepts which comply with the technical idea of the disclosure, based on the principle that the inventor can define the concepts of appropriate terms in order to explain his/her invention in the best way.

In the present specification, the expression that a part “includes” an element does not exclude other elements, but means that other elements may be further included.

Furthers, terms, such as such as “. . . part”, “. . . device”, “. . . module”, means units for processing at least one function or operation, and the units may be implemented as hardware, software, or a combination of the hardware and the software.

Furthermore, the term “at least one” may be defined as a term including the singular and the plural. It will be obvious that even when there is no the term “at least one”, each element may exist in the singular or in the plural, and may imply a singular element or multiple elements.

Furthermore, each element may be provided in the singular or in the plural, and this can be changed depending on embodiments.

Hereinafter, an exemplary embodiment of a reinforcement apparatus and a reinforcement method for optimizing the position of an object based on design data according to an embodiment of the present disclosure will be described with reference to the accompanying drawings.

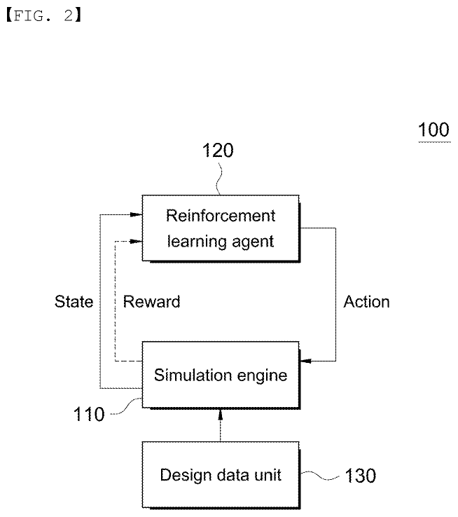

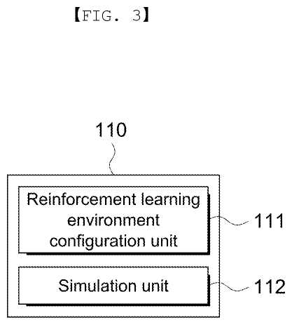

FIG. 2 is a block diagram showing the configuration of a reinforcement learning apparatus for optimizing the position of an object based on design data according to an embodiment of the present disclosure. FIG. 3 is a block diagram showing the configuration of a simulation engine of the reinforcement learning apparatus for optimizing the position of an object based on design data according to the embodiment in FIG. 2.

Referring to FIGS. 2 and 3, a reinforcement learning apparatus 100 for optimizing the position of an object based on design data according to an embodiment of the present disclosure may include a simulation engine 110, a reinforcement learning agent 120, and a design data unit 130 such that a learning environment may be configured based on design data of a user, and an optimal position of a target object installed around a specific object during a designing or manufacturing process may be generated through reinforcement learning using simulation and provided.

The simulation engine 110 may be an element for making an environment for reinforcement learning, and may include a reinforcement learning environment configuration unit 111 and a simulation unit 112 so as to configure a reinforcement environment by implementing a virtual environment in which the simulation engine 110 performs learning while interacting with the reinforcement learning agent 120 through simulation for the placement of a target object performed based on an action provided from the reinforcement learning agent 120.

Furthermore, the simulation engine 110 may include a machine-learning (ML) agent (not shown) such that a reinforcement learning algorithm for training a model of the reinforcement learning agent 120 can be applied.

Here, the ML-agent may transfer information to the reinforcement learning agent 120, and may perform an interface between programs such as “python” for the reinforcement learning agent 120.

Furthermore, the simulation engine 110 may include a web-based graphics library (not shown) so as to be visualizable through a web.

That is, the simulation engine 110 may be configured to use interactive 3D graphics in compatible web browsers by using JavaScript programming language.

The reinforcement learning environment configuration unit 111 may analyze, based on design data including information about all objects, an individual object and position information of the object to generate a predetermined constraint and simulation data constituting a reinforcement learning environment for the individual object.

Here, the design data is data including information about all objects, and may include boundary information in order to adjust the size of an image entering a reinforcement learning state.

Furthermore, since an individual constraint is required to be configured by receiving position information of each object, the design data may include an individual file, and may be formed as a CAD file. The type of CAD file may include files such as FBX or OBJ.

Furthermore, the design data may be formed as a CAD file made by a user such that a learning environment similar to a real environment can be provided.

Furthermore, the design data may be formed as semiconductor design data using a format such as def, lef, or v, or semiconductor design data including netlist data.

Furthermore, a constraint on object information may be configuring whether an object is a target object, a fixed object, an obstacle, etc. in a design process, or when an object is a fixed object, may be a minimum distance between the object and a target object placed therearound, the number of target objects placed therearound, the type of target object placed therearound, and information about configuration of a group of objects having identical characteristics.

Furthermore, the reinforcement learning environment configuration unit 111 may transmit, to the reinforcement learning agent 120, state information to be used for reinforcement learning and reward information based on simulation, and may make a request to the reinforcement learning agent 120 for an action.

That is, the reinforcement learning environment configuration unit 111 may make, based on the generated simulation data constituting a reinforcement learning environment, a request to the reinforcement learning agent 120 for optimization information for the placement of at least one target object around at least one individual object.

The simulation unit 112 may perform simulation for the placement of a target object, based on an action provided from the reinforcement learning agent 120 and state information including target object placement information to be used for reinforcement learning, and may provide the reinforcement learning agent 120 with reward information according to the result of the simulation.

Here, the reward information may be calculated based on the distance between an object and a target object or the position of the target object. In addition, the reward information may be calculated based on a reward according to characteristics of a target object, for example, the placement of target objects around a predetermined object in top/bottom symmetry, left/right symmetry, diagonal symmetry, etc.

The reinforcement learning agent 120 may be an element for performing reinforcement learning based on the state information and the reward information provided from the simulation engine 110 to determine an action such that the placement of a target object around an object is optimized, and may include a reinforcement learning algorithm.

Here, the reinforcement learning algorithm may use one of a value-based approach and a policy-based approach to find an optimal policy for maximizing reward. In the value-based approach, the optimal policy may be derived from an optimal value function approximated based on an agent's experience. In the policy-based approach, an optimal policy separated from value function approximation may be learned, and a trained policy may be improved toward an approximation function.

Furthermore, the reinforcement learning algorithm may allow learning of the reinforcement learning agent 120 to be performed such that the reinforcement learning agent 120 can determine an action by which a target object is placed in an optimal position by means of an angle at which the target object is placed around an object, a distance by which the target object is spaced apart from the object, etc.

The design data unit 130 is an element for providing the simulation engine 110 with design data including information about all objects, and may be a user terminal or a server system in which the design data is stored.

Furthermore, the design data unit 130 may be connected to the simulation engine 110 through a network.

Hereinafter, a description will be made of a reinforcement learning method for optimizing the position of an object based on design data according to an embodiment of the present disclosure.

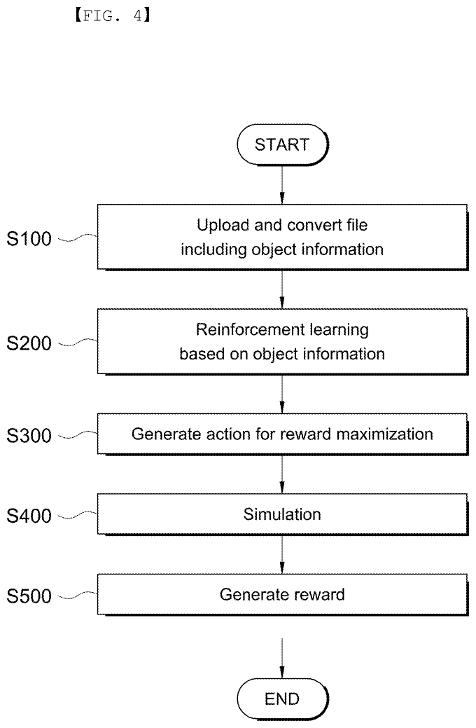

FIG. 4 is a flowchart showing a reinforcement learning method for optimizing the position of an object based on design data according to an embodiment of the present disclosure.

Referring to FIGS. 2 to 4, in the reinforcement learning method for optimizing the position of an object based on design data according to an embodiment of the present disclosure, when design data including information about all objects is uploaded from the design data unit 130, the simulation engine 110 may analyze, based on the design data including information about all objects, an individual object and position information of the object to generate a predetermined constraint and simulation data constituting a reinforcement environment for the individual object (S100).

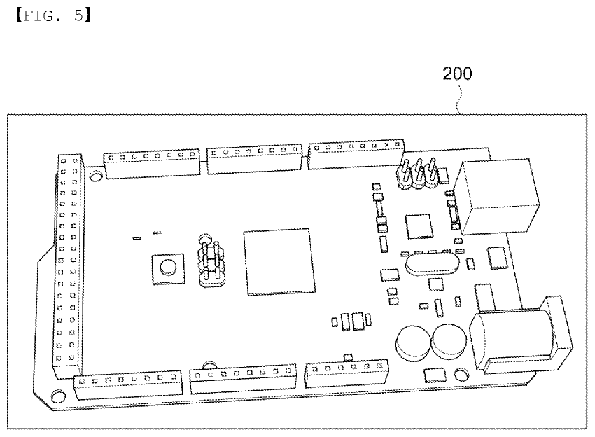

That is, the design data uploaded in operation S100 may be a CAD file including about all object as in FIG. 5, and a design data image 200 including boundary information may be output through a display means in order to adjust the size of the image entering a reinforcement learning state.

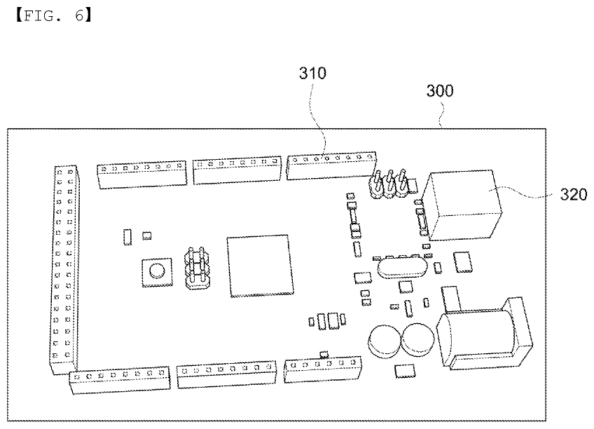

Furthermore, as in FIG. 6, the design data uploaded in operation S100 may be output as an individual object information data image 300 including individual file information, and individual constraint configuration information based on the characteristics of an object such as an obstacle 320 may be configured with respect to an individual object 310.

That is, in operation S100, the simulation engine 110 may receive position information of individual objects to configure an object as a target object, a fixed object, an obstacle, etc. in a designing process for each object, or, when the object is a fixed object, may configure an individual constraint, such as a minimum distance between the object and a target object placed therearound, the number of target objects placed therearound, the type of target object placed therearound, and information about configuration of group of objects having identical characteristics, or a configuration in which a predetermined obstacle does not overlap the target object.

Furthermore, in operation S100, when a CAD file is configured as a base line and when configuration of a constraint on an individual object is completed, the simulation engine 110 may generate may use the position of an object and the configured information as learning environment information to generate simulation data constituting a reinforcement learning environment.

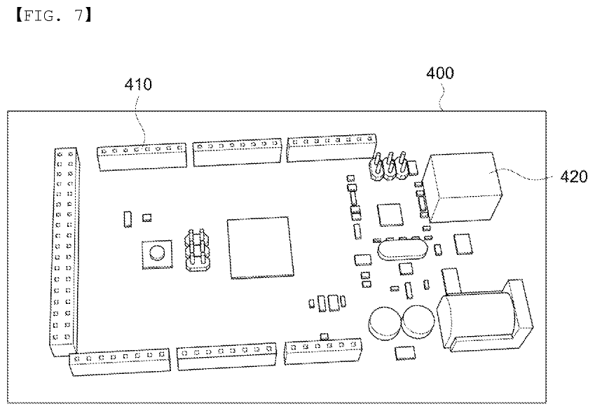

That is, as in FIG. 7, in a simulation data image 400, simulation data constituting a reinforcement learning environment in which an obstacle 420, etc. are placed around an individual object 410 may be generated.

Furthermore, in operation S100, the simulation engine 110 may convert the simulation data into an extensible markup language (XML) file such that the simulation data can be visualized and used through a web and used.

Subsequently, the reinforcement learning agent 120 may receive, from the simulation engine 110, a request for optimization of the placement of an individual object and the placement of a target object around the object, based on the simulation data constituting a reinforcement environment.

When the request for optimization of the placement of a target object around an object is received, the reinforcement learning agent 120 may perform reinforcement learning based on reward information and state information including target object placement information that is used for the reinforcement learning and collected from the simulation engine 110 (S200).

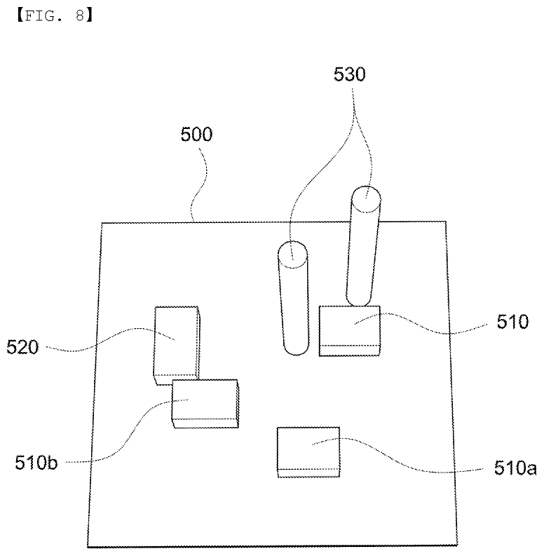

That is, the reinforcement learning agent 120 may use a reinforcement learning algorithm to perform learning such that an action by which target objects 530 are placed around predetermined objects 510, 510a, 510b in, for example, a simulation image 500 as in FIG. 8, and, at this time, are placed in optimal positions can be determined by means of angles that the target objects 530 form with the objects 510, 510a, and 510b, distances by which the target objects 530 is spaced apart from the objects 510, 510a, and 510b, directions in which the target objects 530 are symmetric to the object 510, 510a, and 510b, etc.

Furthermore, through the reinforcement learning algorithm, positions in which the target objects 530 are placed may be determined by reflecting the position of an object which is configured to be an obstacle 520.

Furthermore, the reinforcement learning agent 120 may determine an action such that the placement of target objects is optimized through reinforcement learning (S300).

Subsequently, the simulation engine 110 may perform simulation for the placement of the target objects, based on the action provided from the reinforcement learning agent 120 (S400).

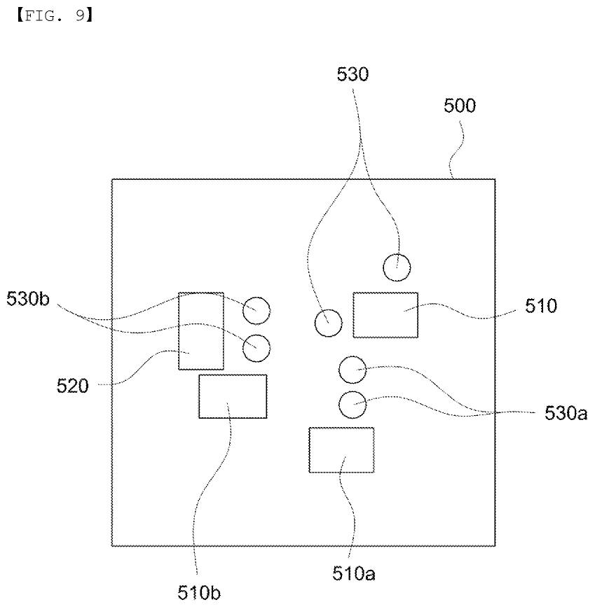

That is, as in FIG. 9, target objects 530, 530a, and 530b may be placed around objects 510, 510a, and 510b and around an obstacle 520 in a simulation image 500, and simulation may be performed.

According to the simulation performed in operation S400, the simulation engine 110 may generate reward information based on the distance between an object and a target object or the position of the target object (S500), and the generated reward information may be provided to the reinforcement learning agent 120.

Furthermore, in operation S400, in relation to the reward information, for example, when the distance between an object and a target object is to be short, distance information itself may be provided as a negative reward so that the distance between the object and the target object is as close to “0” as possible.

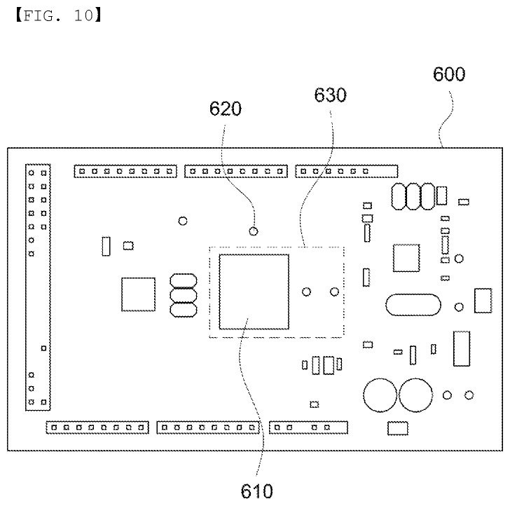

For example, as shown in FIG. 10, when the distance between an object 610 and a target object 620 is positioned at a set boundary 630 in a learning result image 600, a negative (-) reward value may be generated as reward information and may be provided to the reinforcement learning agent 120 so as to be reflected when a next action is determined.

Furthermore, in relation to the reward information, the distance may be determined in consideration of the thickness of the target object 620.

Therefore, when the simulation engine 110 provides a state including environment information to the reinforcement learning agent 120, and when the reinforcement learning agent 120 determines, based on the provided state, an optimal action through reinforcement learning, the simulation engine 110 may generate a reward for simulation result through simulation based on the action, and may provide the reward to the reinforcement learning agent 120, so that the reinforcement learning agent 120 can reflect reward information to determine the next action.

Furthermore, the present disclosure is advantageous in that a learning environment may be configured based on design data of a user, and the optimal position of a target object installed around a specific object during a design or manufacturing process may be generated and provided through reinforcement learning using simulation.

Furthermore, the present disclosure is advantageous in that design accuracy may be improved by providing a learning environment similar to a real environment, based on data designed by the user while the user performs 3D designing. The work efficiency may be improved by automatically generating the optimized position of a target object through reinforcement learning, based on data designed by the user.

As described above, the present disclosure has been described with reference to preferred embodiments of the present disclosure. However, those skilled in the art will understand that the present disclosure can be variously modified and changed without departing from the idea and scope of the present disclosure described in the following claims.

Furthermore, reference numbers described in claims of the present disclosure are only provided for clarity and convenience of description, and are not limited thereto. In the process of describing embodiments, the thickness of lines or the size of elements illustrated in the drawings may be exaggerated for clarity and convenience of description.

Furthermore, the terms described above are terms defined in consideration of the functions in the present disclosure, and may vary depending on intention of a user or operator, or customs.

Therefore, the interpretation of the terms should be made based on the contents throughout the specification.

Furthermore, even when being not explicitly illustrated or described, it is obvious that those skilled in the art, to which the present disclosure belongs, can make various modifications including the technical idea of the present disclosure from the description of the present disclosure. These modifications still within the scope of the present disclosure.

Furthermore, the above embodiments described with reference to the accompanying drawings have been described for the purpose of describing the present disclosure, and the scope of the present disclosure is not limited to these embodiments.

What is claimed is:

1. A reinforcement learning apparatus for optimizing a position of an object based on design data, the apparatus comprising:
a simulation engine (110) configured to analyze, based on design data comprising information about all objects, an individual object and position information of the object, generate simulation data constituting a reinforcement environment in which a predetermined constraint is configured for the analyzed individual object, request optimization information for placing a target object around at least one individual object, perform simulation for the placement of the target object, based on state information comprising target object placement information used for reinforcement learning and an action provided from a reinforcement learning agent (120), and provide reward information according to the simulation result as feedback on decision-making of the reinforcement learning agent (120);
the reinforcement learning agent (120) configured to perform reinforcement learning based on the state information and the reward information provided from the simulation engine (110) to determine an action such that the placement of the target object around the object is optimized; and
a design data unit (130) configured to provide, to the simulation engine (110), the design data comprising the information about the all objects.

2. The apparatus of claim 1, wherein the design data is semiconductor design data comprising CAD data or netlist data.

3. The apparatus of claim 1, wherein an application program visualized through a web is additionally installed in the simulation engine (110).

4. The apparatus of claim 1, wherein the simulation engine (110) comprises:
a reinforcement learning environment configuration unit (111) configured to analyze, based on design data comprising information about all objects, an individual object and position information of the object, generate a predetermined constraint and simulation data constituting a reinforcement environment for the individual object, and make, based on the simulation data, a request to the reinforcement learning agent (120) for optimization information for placing a target object around at least one individual object; and
a simulation unit (112) configured to perform, based on an action received from the reinforcement learning agent, simulation for configuring a reinforcement learning environment for the placement of the target object, and provide, to the reinforcement learning agent (120), reward information and state information comprising target object placement information used for reinforcement learning.

5. The apparatus of claim 4, wherein the reward information is calculated based on a distance between an object and a target object or a position of the target object.

6. A reinforcement learning method for optimizing a position of an object based on design data, the method comprising:
a) analyzing, by a simulation engine (110), an individual object and position information of the object when design data comprising information about all objects is uploaded, and generating simulation data constituting a reinforcement environment in which a predetermined constraint is configured for the individual object;
b) when an optimization request for placement of a target object around an individual object based on the simulation data is received from the simulation engine (110), performing, by a reinforcement learning agent (120), reinforcement learning based on reward information and state information comprising target object placement information, which is collected from the simulation engine (110) and used for the reinforcement learning, to determine an action such that the placement of the target object is optimized; and
c) performing, by the simulation engine (110), simulation for configuring a reinforcement environment for the placement of the target object, based on an action provided from the reinforcement learning agent (120), and providing, to the reinforcement learning agent (120), reward information according to the result of performing the simulation as feedback on decision-making of the reinforcement learning agent (120) and the state information comprising the target object placement information used for reinforcement learning,
wherein the reward information in operation c) is calculated based on a distance between an object and a target object or a position of the target object.

7. The method of claim 6, wherein the design data in operation a) is semiconductor design data comprising CAD data or netlist data.

8. The method of claim 6, further comprising converting the simulation data in operation a) into an extensible markup language (XML) file such that the simulation data is used through a web.
